(19) United States
(12) Patent Application Publication
(10) Pub. No.: US 2025/0308326 A1
(43) Pub. Date: Oct. 2, 2025

(54) RECORD REVEAL SYSTEMS AND METHODS

(71) Applicant: Primero Games, LLC, Norcross, GA (US)

(72) Inventors: Michael M. Macke, Duluth, GA (US); Barry W. Rutherford, Duluth, GA (US); Mark C. Nizdil, Duluth, GA (US)

(21) Appl. No.: 18/620,349

(22) Filed: Mar. 28, 2024

(51) Int. Cl. G07F 17/32; G07F 17/42

(52) U.S. Cl. CPC G07F 17/3234; G07F 17/3211; G07F 17/3237; G07F 17/3241; G07F 17/42

(57) ABSTRACT

The gaming system can generate an outcome for a wagering game. The gaming system can generate a record, which can include the outcome from the wagering game, and store the record in a data store. The gaming system can render the outcome on a display. In response to an event, the gaming system can determine a delivery option based on the record. The gaming system can provide a ticket based on the delivery option. The ticket can be configured to display the record in response to an action and hide the record in absence of the action.

### TECHNICAL FIELD

The present systems and processes relate to utilizing computing technology to generate, provide, and reveal a record for a wagering game on gaming platform technologies.

### BACKGROUND

Gaming devices can generate outcomes for wagering games quickly in succession. Patrons playing a wagering game may wish to track the history of the wagering games, the outcome for each wagering game, and the credits or meters associated with each outcome. While a gaming device may display the outcome of an individual wagering game after generating the outcome, gaming devices do not generate or provide a record of the wagering games for patron, which may discourage patrons from playing wagering games on a gaming device. Therefore, there is a long-felt but unresolved need for gaming technology to generate, provide, and reveal a wagering game record.

### BRIEF SUMMARY OF THE DISCLOSURE

Aspects of the present disclosure generally relate to generating, providing, and revealing a record for a wagering game on a gaming device. A gaming device can generate outcomes for a wagering game. When the gaming device begins generating outcomes for the wagering game, the gaming device can initiate or begin a record. The record can include a log or history of every wagering game and outcome generated by the gaming device. The record can include a balance of meters or credits, including the credits won or lost for each wagering game. Each time that the gaming device generates an outcome for a wagering game, the gaming device can amend the record to include the recent wagering game. The gaming device can render the outcome of the recent wagering game or the record on the display of the gaming device.

The gaming device can provide the record in response to an event. The event can include generating an outcome or receiving a request to cash out. The event can include a timer exceeding a predetermined time threshold. For example, the gaming device can initiate a timer for the wagering game and provide the record once the timer exceeds the predetermined time threshold. The event can include a game counter exceeding a predetermined game counter threshold. For example, the gaming device can initiate a game counter and increment the game counter each time an outcome is generated. When the game counter exceeds the predetermined game counter threshold, the gaming device can provide the ticket.

The gaming device can determine a delivery option for providing the record. The delivery option can include a method or manner of providing the record to the current patron. The delivery option can be predetermined based on a rule or determined based on the patron account, the outcomes, the record, or the type of wagering game. The delivery options can include, but are not limited to, generating a scannable code, generating a custom URL, associating the record with a patron account, or sending the record to a phone number or email address provided by the patron. After determining the delivery option, the gaming device can provide the record by printing a ticket. For example, the gaming device can generate a scannable code and print the scannable code on a ticket. As another example, the gaming device can generate a custom URL and print the custom URL. As another example, the gaming device can associate the record with a patron account and print instructions for the patron to access the patron account. As another example, the gaming device can request a phone number or email address, transmit the record in a message to the phone number or email address, and print instructions to access the record via the message.

The ticket can reveal the record in response to an action by the patron. For example, if the ticket includes a scannable code, the record can be revealed by scanning the scannable code. As another example, if the ticket includes a custom URL, the record can be revealed by accessing the custom URL. As another example, if the ticket includes instructions to access a patron account, the record can be revealed by accessing the patron account. As another example, if the ticket includes instructions to access a message containing the record, the record can be revealed by accessing the message.

The above and further features of the disclosed systems and methods will be recognized from the following detailed descriptions and drawings of various embodiments.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exemplary record reveal system according to various embodiments of the present disclosure.

FIG. 2 illustrates an exemplary networked environment according to various embodiments of the present disclosure.

FIG. 3 illustrates an exemplary overall process for the disclosed system according to various embodiments of the present disclosure.

FIG. 4 illustrates an exemplary process for determining a delivery option and providing the record according to various embodiments of the present disclosure.

FIG. 5 illustrates an exemplary user interface rendered on a display of the mobile device according to various embodiments of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Exemplary Embodiments

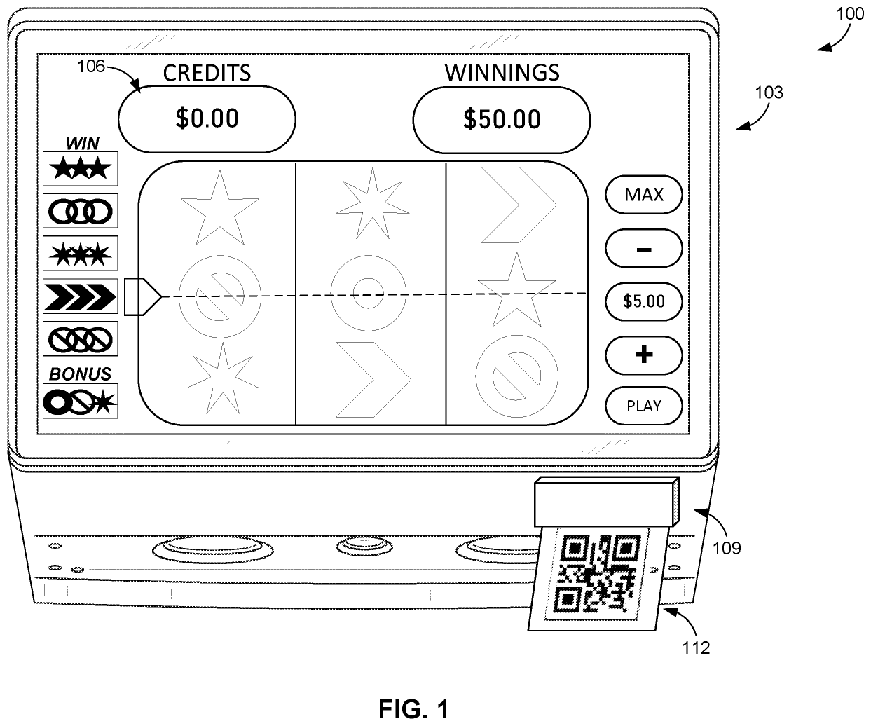

Referring now to the figures, for the purposes of example and explanation of the fundamental processes and components of the disclosed systems and processes, reference is made to FIG. 1, which illustrates the record reveal system 100. The record reveal system 100 can include the gaming device 103. The gaming device 103 can receive inputs (e.g., stake, wager) and generate outcomes for a wagering game. The outcomes can include a winning outcome and losing outcome. If the outcome is a winning outcome, the gaming device 103 can increase the credits 106. If the outcome is a losing outcome, the gaming device 103 can decrease the credits 106.

When the gaming device 103 begins generating outcomes, the gaming device 103 can initiate a record. The record can include each wagering game, each outcome, and the balance of the credits 106. Each time that the gaming device 103 generates an outcome for the wagering game, the gaming device 103 can amend the record to include the most recent wagering game and outcome. The gaming device 103 can provide the record to the patron in response to an event. For example, the gaming device 103 can provide the record to the patron in response to generating an outcome, receiving a request to cash out, a game counter exceeding a predetermined game threshold, or a timer exceeding a predetermined time threshold.

The gaming device 103 can provide the record by printing a ticket. For example, the gaming device 103 can generate a scannable code and print the scannable code on the ticket. As another example, the gaming device 103 can generate a custom URL and print the custom URL. As another example, the gaming device 103 can associate the record with a patron account and print instructions for the patron to access the patron account. As another example, the gaming device 103 can request a phone number or email address, transmit the record in a message to the phone number or email address, and print instructions to access the record via the message.

In some embodiments, the gaming device 103 can eject a preprinted scannable code. In one embodiment, a printer 109 can have a set of preprinted tickets with scannable codes on them. In one embodiment, the pre-printed code can be a scratch off ticket with the scannable code covered by scratch off material. For example, the gaming device 103 can eject a series of pre-printed tickets that include scannable codes. The pre-printed tickets can include pull tab tickets, scratch off tickets, or other tickets.

The gaming device 103 can generate a visual representation of the scannable code in memory. The gaming device 103 can transmit the data representing the visual representation to the printer 109. The printer 109 can receive the scannable code via a connection, such as a wireless or wired connection. The printer 109 can render the scannable code on a medium (referred to as a ticket herein), such as a paper ticket, a foil coated paper ticket, a cardboard ticket, a pull tab ticket, a scratch off ticket, a holographic paper, a thermal paper, or some other medium. For example, the printer 109 can general a physical representation of the visual representation of the scannable code by printing the visual representation on the medium.

The ticket can reveal the record in response to an action by the patron. For example, if the ticket includes a scannable code, the record can be revealed by scanning the scannable code. In exemplary record reveal system 100, the gaming device 103 includes a printer 109, which can print a ticket 112. As another example, if the ticket includes a custom URL, the record can be revealed by accessing the custom URL. As another example, if the ticket includes instructions to access a patron account, the record can be revealed by accessing the patron account. As another example, if the ticket includes instructions to access a message containing the record, the record can be revealed by accessing the message.

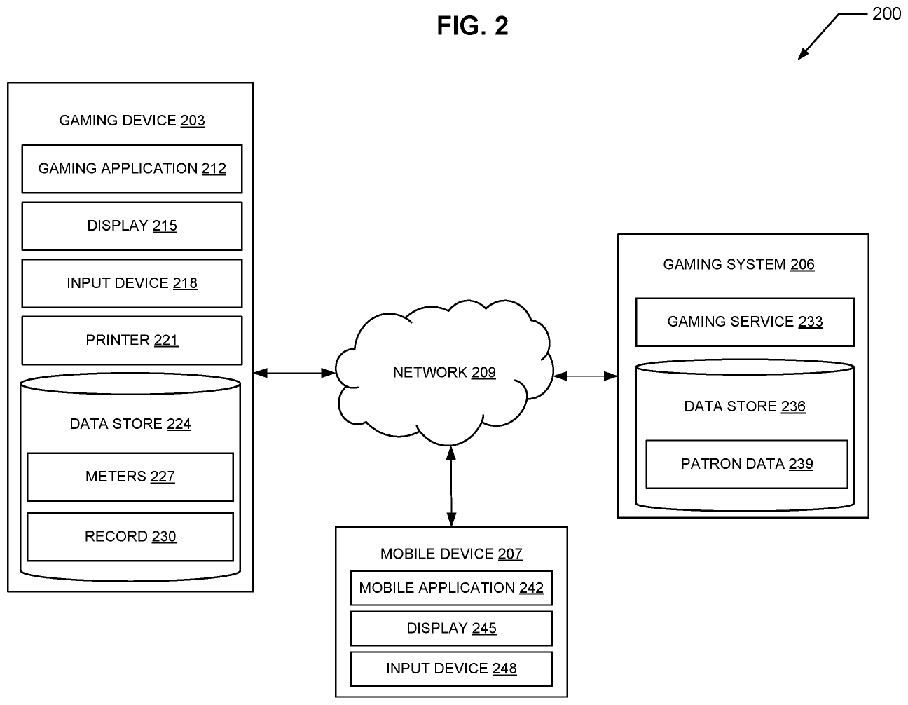

Referring now to FIG. 2, shown is an exemplary networked environment 200 for the record reveal system according to various embodiments of the present disclosure. As will be understood and appreciated, the exemplary networked environment 200 shown in FIG. 2 represents merely one approach or embodiment of the present system, and other aspects are used according to various embodiments of the present system. Exemplary networked environment 200 can include, but is not limited to, the gaming device 203, the gaming system 206, and a mobile device 207 connected over a network 209.

According to various embodiments, the gaming device 203 can include any device capable of accessing network 209 including, but not limited to, a computer, smartphone, tablets, or other device. The gaming device 203 can be a gaming cabinet, an amusement device, a slot machine, or other gaming device with a processor-based system such as a computer system. The gaming device 203 can include a processor and a data store 224. The gaming device 203 can include a display 215 on which various user interfaces can be rendered to allow users to configure, monitor, control, and command various functions of the gaming application 212. The gaming device 203 can include the input device 218 for a user to provide various inputs (e.g., selections, wagers, credentials). The input device 218 can include one or more buttons, touch screens including three-dimensional or pressure-based touch screens, camera, finger print, scanners, accelerometer, retinal scanner, gyroscope, magnetometer, or other input devices. The input device 218 can also include a bill acceptor, a player tracking module, a ticket printer, or some other device. The gaming device 203 can include a printer 221 for printing tickets. The data store 224 can store data from the gaming device 203, including but not limited to the meters 227 and the record 230.

In various embodiments, gaming device 203 can include multiple computing devices. Regardless, the gaming device 203 can include one or more processors and memory having instructions stored thereon that, when executed by the one or more processors, cause the gaming device 203 to perform one, some, or all of the actions, methods, steps, or functionalities provided herein. The gaming device 203 can be configured to execute various applications, such as the gaming application 212 and/or other applications. The gaming application 212 may be executed by the gaming device 203, for example, to access network content served up by the gaming system 206, and/or other servers, thereby rendering various user interfaces on the display 215. While the specification discusses various functionality as being performed by the gaming application 212 or the gaming service 233, it is understood that this functionality may be performed by the gaming service 233, gaming application 212, or both in coordination.

The gaming application 212 can receive bets and generate outcomes for wagering games. Based on the outcome of the wagering game, the gaming application 212 can increment one or more meters 227 associated with the wagering game, including the credits. When the wagering game begins, the gaming application 212 can initiate a record 230 of the wagering games. The record 230 can include the wagering game, the meters 227, including the credits (e.g., the balance of the credits, the stake or wager for each wagering game, the amount of credits won or lost). Each time that the gaming application 212 generates an outcome, the gaming application 212 can update the record 230.

The gaming application 212 can authenticate the user via a player tracking module, a radio frequency identifier (RFID) reader, a card reader, a near field communication (NFC), such as Bluetooth circuitry, Wi-Fi circuitry, or other wireless antenna-based technology. In some embodiments, the patron can insert a patron tracking card into the gaming device 203 to authenticate the patron account. In another embodiment, the gaming device 203 can read a user identifier associated with the patron from using near field communication (NFC). In some embodiments, the gaming application 212 or the gaming system 206 can authenticate the credentials provided against the patron data 239. After authenticating the user or patron account, the gaming application 212 or the gaming service 233 can associate the record with the patron data 239.

The gaming application 212 can provide the record to a patron in response to an event (e.g., generating an outcome for a wagering game, receiving a request to cash out, exceeding a game counter threshold, exceeding a time threshold). For example, the gaming application 212 can provide the record in response to receiving a request to cash out the wagering game. As another example, the gaming application 212 can provide the ticket in response to generating an outcome for the wagering game. In this example, the gaming application 212 provide the record each time that the gaming application 212 generates an outcome. As another example, when the wagering game begins, the gaming application 212 can begin a game counter. Each time the wagering game generates an outcome, the gaming application 212 can increment the game counter. Each time the gaming application 212 increments the game counter, the gaming application 212 can determine if the game counter exceeds a predetermined game threshold. If the gaming application 212 determines that the game counter exceeds a predetermined game threshold, the gaming application 212 can provide the record. As another example, when the wagering game begins, the gaming application 212 can begin or initiate a timer. Each time the wagering game generates an outcome, the gaming application 212 can determine if the timer exceeds a predetermined time threshold. If the gaming application 212 determines that the timer exceeds a predetermined time threshold, the gaming application 212 can provide the record.

The gaming application 212 can provide the record by transmitting a request to the printer 221 to print a ticket. The ticket can reveal the record to a patron in response to an action by the patron. For example, the gaming application 212 or the gaming service 233 can generate a scannable code that the printer 221 can print on a ticket. When the patron scans the scannable code with a mobile device 207, the record can be displayed. As another example, the gaming application 212 or the gaming service 233 can generate a custom URL that the printer 221 can print on a ticket. When the patron accesses the custom URL on a computing device, the record can be displayed. As another example, the gaming application 212 receive credentials for a patron account via the input device 218. The gaming application 212 can transmit the credentials to the gaming system 206 for authentication. Once the credentials have been authenticated, the gaming application 212 can transmit the record to the gaming system 206 and the gaming system 206 can associate the record with the patron data 239. The printer 221 can print a ticket with instructions for the patron to access the record via the patron account. As another example, the gaming application 212 can request a phone number or email address and receive the phone number or email address from the input device 218. The gaming application 212 or the gaming service 233 can transmit a message containing the record to the phone number or email address. The printer 221 can print a ticket with the phone number or email address and instructions for the patron to access the record via the message.

The mobile device 207 can include a mobile application 242, a display 245, and an input device 248. The mobile application 242 can be part of the operating system or other software, such as an app or program. The mobile application 242 can be downloaded from a In some embodiments, the mobile application 242 can be camera software and/or a web browser. The camera software can analyze a camera feed from the input device 248, such as a camera. The input device 248 can include one or more cameras, one or more microphones, one or more touch screens, one or more buttons, or other input devices 248. The camera software can identify a scannable code in the camera feed. The camera software can extract a Universal Resource Locator (URL) from the scannable code and open the URL via a web browser on the display 245.

In one embodiment, the scannable code can correspond to a logo or image. The mobile application 242 can identify the logo or image in a camera feed. The mobile application 242 can render a user interface over the logo or image. In some embodiments, the mobile application 242 can generate the user interface as an overlay on the video feed. The mobile application 242 can show the overlay as augmented reality. The mobile application 242 can communicate with the gaming system 206 and/or gaming device 203 to receive data about the scannable code. For example, the mobile application 242 can query the gaming service 233 or gaming application 212 to obtain outcomes of one or more wagering games. The mobile application 242 can obtain the record 230 including the outcomes over the network. The mobile application 242 can render a user interface illustrating the outcomes over the scannable code.

The elements of the gaming system 206 can be provided via one or more computing devices that may be arranged, for example, in one or more server banks or computer banks or other arrangements. Such computing devices can be located in a single installation or may be distributed among many different geographical locations. For example, the gaming system 206 can include one or more computing devices that together may include a hosted computing resource, a grid computing resource, or any other distributed computing arrangement. In some cases, the gaming system 206 can correspond to an elastic computing resource where the allotted capacity of processing, network, storage, or other computing-related resources may vary over time. Regardless, the gaming system 206 can include one or more processors and memory having instructions stored thereon that, when executed by the one or more processors, cause the gaming system 206 to perform one, some, or all of the actions, methods, steps, or functionalities provided herein.

The gaming system 206 can include a gaming service 233 and the data store 236. The gaming service 233 can correspond to one or more software executables that can be executed by the gaming system 206 to perform the functionality described herein. Various data can be stored in the data store 236, including but not limited to, the patron data 239.

The gaming service 233 can communicate with multiple gaming devices 203. In some embodiments, the gaming system 206 can include a casino management system that can communicate with multiple gaming devices 203 throughout the casino. The gaming service 233 can receive and transmit messages and data with multiple gaming devices 203. The gaming service 233 can authenticate user or patron account credentials from the multiple gaming devices 203. For example, the gaming service 233 can communicate with one or more gaming devices 203 using gaming protocols, such as Slot Accounting System (SAS), Game To System (G2S), pulse protocol, or another gaming protocol or combination thereof. In some embodiments, the gaming service 233 can communicate to one or more gaming devices 203 via a first gaming protocol and one or more second gaming devices 203 via a second gaming protocol.

The network 209 can include, for example, the Internet, intranets, extranets, wide area networks (WANs), local area networks (LANs), wired networks, wireless networks, or other suitable networks, etc., or any combination of two or more such networks.

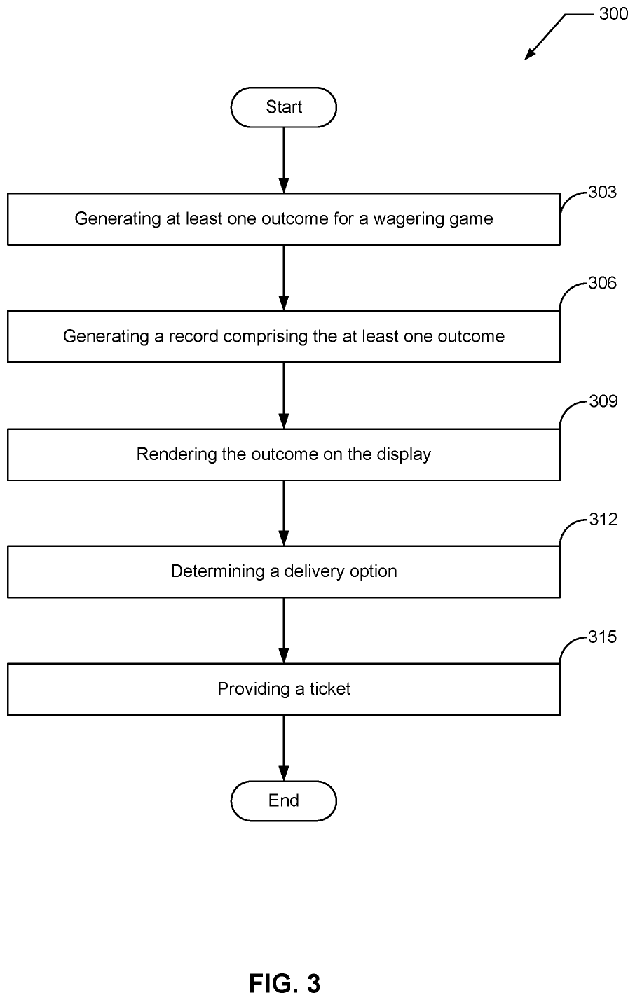

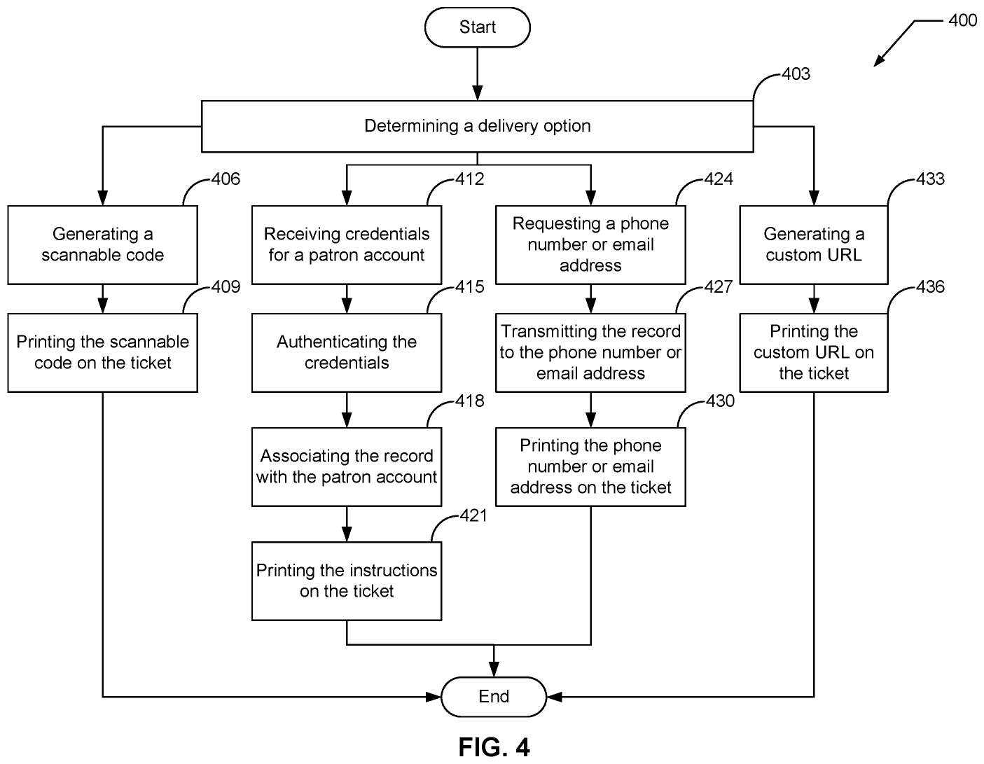

Referring now to FIG. 3, shown is an exemplary, high-level overview process 300 according to various embodiments of the present disclosure. As will be understood by one having ordinary skill in the art, the steps and processes shown in FIGS. 3 and 4 may operate concurrently and continuously, are generally asynchronous and independent, can be performed in part or in whole by a combination of one or more of the gaming device 203 and the gaming system 206 and are not necessarily performed in the order shown and various steps can be executed linearly or in parallel. Process 300 can be performed entirely, partially, or in coordination with the gaming application 212 and the gaming service 233.

At step 303, the process 300 can include generating at least one outcome for a wagering game. The gaming application 212 can generate at least one outcome for the wagering game. Generating the outcome can include receiving a bet (e.g., input) for the wagering game. The bet can include a stake or wager (e.g., a portion of the credits associated with the wagering game). Multiple bets can be received for multiple wagering games and multiple outcomes can be generated for the one wagering game or multiple wagering games. As an example, the gaming application 212 can iteratively receive a bet and generate an outcome for wagering games. After receiving the bet, an outcome can be generated for each wagering game. The outcome can include a winning outcome or a losing outcome. Based on the outcome of the wagering game, the gaming application 212 can increment one or more meters 227 associated with the wagering game, including the credits. If the outcome is a winning outcome, the credits associated with the wagering game can increase. If the outcome is a losing outcome, the credits associated with the wagering game can decrease.

At step 306, the process 300 can include generating a record. The gaming application 212 can generate the record 230. The record can include one or more wagering games, the outcomes associated with each wagering game, the meters 227, the balance of the credits (e.g., the balance of the credits, the stake or wager for each wagering game, the amount of credits won or lost). The record can be stored in the data store 224 of the gaming device 203 as the record 230. The gaming device 203 can transmit the record to the data store 236 of the gaming system 206. The gaming system 206 can associate the record with the patron data 239.

At step 309, the process 300 can include rendering outcome on the display. The gaming device 203 can render the outcome on the display 215. For a winning outcome, a celebration can be rendered on the display. For example, the celebration can include the credits won for the wagering game. For a losing outcome, a loss can be rendered on the display. For example, the celebration can include the credits lost for the wagering game. The record can be presented or rendered on the display with the outcome.

At step 312, the process 300 can include determining a delivery option. The gaming application 212 can determine a delivery option. The delivery option can include a method or manner of providing the record to the current patron. The delivery options can include, but are not limited to, generating a scannable code, generating a custom URL, associating the record with a patron account, or sending the record to a phone number or email address provided by the patron. The delivery option can be predetermined or determined based on the patron account, the outcomes, the record, or the type of wagering game.

At step 315, the process 300 can include providing a ticket. The gaming device 203 can provide the ticket. The gaming device 203 can provide the ticket in response to an event (e.g., receiving a request to cash out, generating an outcome for the wagering game, exceeding a game counter threshold, exceeding a time threshold). For example, the gaming device 203 can provide the ticket in response to receiving a request to cash out the wagering game. As another example, the gaming device 203 can provide the ticket in response to generating an outcome for the wagering game. In this example, the gaming device 203 can provide a ticket each time that the gaming device 203 generates an outcome for a wagering game. As another example, when the wagering game begins, the gaming application 212 can begin a game counter. Each time the wagering game generates an outcome, the gaming application 212 can increment the game counter. Each time the gaming application 212 increments the game counter, the gaming application 212 can determine if the game counter exceeds a predetermined game threshold. If the gaming application 212 determines that the game counter exceeds a predetermined game threshold, the gaming device 203 can provide the ticket. As another example, when the wagering game begins, the gaming application 212 can begin or initiate a timer. Each time the wagering game generates an outcome, the gaming application 212 can determine if the timer exceeds a predetermined time threshold. If the gaming application 212 determines that the timer exceeds a predetermined time threshold, the gaming device 203 can provide the ticket.

The ticket can include a printed, paper ticket or a digital ticket. For example, the gaming device 203 can provide the ticket by printing the ticket via the printer 221. The content of the ticket can on the delivery option determined at step 312. For example, the ticket can include a scannable code. As another example, the ticket can include a custom URL. As another example, the ticket can include instructions to access a patron account. As another example, the ticket can include a phone number or email address that was provided to the gaming application 212 via the input device 218.

The ticket can reveal the record to a patron in response to an action by the patron. For example, after the ticket is printed, the ticket can hide or conceal the record. After the patron performs an action, the ticket can display or reveal or be used to display or reveal the record. For example, if the ticket includes a scannable code, the patron can scan the code with a mobile device 207. In response to scanning the code, the record can be rendered on a display of the mobile device 207. As another example, if the ticket includes a custom URL, the patron can access the custom URL using a browser on a computing device. In response to accessing the custom URL, the record can be rendered on a display of the computing device. As another example, if the ticket includes instructions to access a patron account, the patron can access the patron account via a gaming application or a browser on a computing device. In response to accessing the patron account, the record can be rendered on a display of the computing device. As another example, if the ticket includes a phone number or email address, the gaming application 212 can send the record in a message to the phone number or email address and the patron can access the record via the message on a computing device. In response to accessing the record via the message, the record can be rendered on a display of the computing device.

When the record is revealed using the ticket, the record can be associated with a patron account. For example, the credits and meters from the record can be associated with the patron account. As another example, when the record is associated with the patron account, a game feature can be enabled for the patron account (e.g., a set of graphics, a wild symbol, a bonus game, a payback feature, an upgraded pay table, nudging attempts, a visual skin, a game of skill, assigning the patron account to a particular level of a progressive jackpot, eligibility to win a progressive jackpot, a previously-unavailable game).

Referring now to FIG. 4, shown is an exemplary process 400 for determining a delivery option and providing the record and ticket according to various embodiments of the present disclosure. As will be understood, the process 400 can operate before, during, or after any of the steps in the process 300. For example, the process 400 can operate during steps 312 and 315 of the process 300. Process 400 can be performed entirely, partially, or in coordination with the gaming device 203 and the gaming system 206. At step 403, the process 400 can include determining a delivery option. The gaming application 212 can determine a delivery option. The delivery option can include a method or manner of providing the record to the current patron. The delivery options can include, but are not limited to, generating a scannable code, generating a custom URL, associating the record with a patron account, or sending the record to a phone number or email address provided by the patron. The delivery option can be predetermined based on rules stored in the data store 224 of the gaming device 203 or the data store 236 of the gaming system 206. The delivery option can be determined based on the patron account, the outcomes, the record, or the type of wagering game. For example, if the gaming application 212 has authenticated a patron account, the record can be associated with the patron account rather than generating a scannable code or custom URL. In some embodiments, multiple delivery option can be selected.

Depending on the delivery option selected at step 403, the process 400 can proceed to step 406, step 412, step 424, and/or step 433. At step 406, the process 400 can include generating a scannable code. The gaming application 212 or the gaming system 206 can generate the scannable code. When scanned with a mobile device 207, the scannable code can facilitate access to the record. At step 409, the process 400 can include printing the scannable code on the ticket. The gaming device 203 can print the ticket via the printer 221.

At step 412, the process 400 can include receiving credentials for a patron account. The credentials can be received by the gaming application 212. For example, the gaming application 212 can receive the credentials via the input device 218. As another example, the gaming application 212 can receive the credentials via a player tracking module, a radio frequency identifier (RFID) reader, a card reader, a near field communication (NFC), such as Bluetooth circuitry, Wi-Fi circuitry, or other wireless antenna-based technology. In some embodiments, the patron can insert a patron tracking card into the gaming device 203 and the gaming application 212 can receive the credentials from the patron tracking card. In another embodiment, the gaming device 203 can read a user identifier associated with the patron from using near field communication (NFC).

At step 415, the process 400 can include authenticating the credentials. The credentials can be authenticated by the gaming application 212 and the gaming service 233. After the gaming application 212 receives the credentials, the gaming application 212 can transmit the credentials to the gaming service 233. The gaming service 233 can authenticate the credentials based on the patron data 239. If the gaming service 233 successfully authenticates the credentials, the gaming service 233 can transmit a success message to the gaming application 212.

At step 418, the process 400 can include associating the record with the patron account. The gaming application 212 and/or the gaming service 233 can associate the record with the patron account. The gaming application 212 can transmit the record to the gaming service 233 and the gaming service 233 can associate the record with the patron data 239. At step 421, the gaming device 203 can print instructions, on the ticket, for the patron to access the record via the patron account. For example, the instructions can direct the patron to access the patron account, and once accessed, the record can be displayed.

At step 424, the process 400 can include requesting a phone number or email address. The gaming application 212 can request a phone number or email address from a current patron. The gaming application 212 can receive the phone number or email address via the input device 218. At step 427, the process 400 can include transmitting the record in a message to the phone number or the email address. The gaming application 212 and/or the gaming service 233 can transmit the record in a message. At step 430, the process 400 can include printing the phone number or the email address on the ticket. The gaming device 203 can print the phone number or the email address on the ticket on the ticket via the printer 221. The ticket can include instructions for the patron to check for the message.

At step 433, the process 400 can include generating a custom URL. The gaming application 212 or the gaming system 206 can generate the custom URL. When the custom URL is accessed by a browser, the custom URL can be used to access the record. At step 436, the process 400 can include printing the custom URL on the ticket. The gaming device 203 can print the ticket via the printer 221.

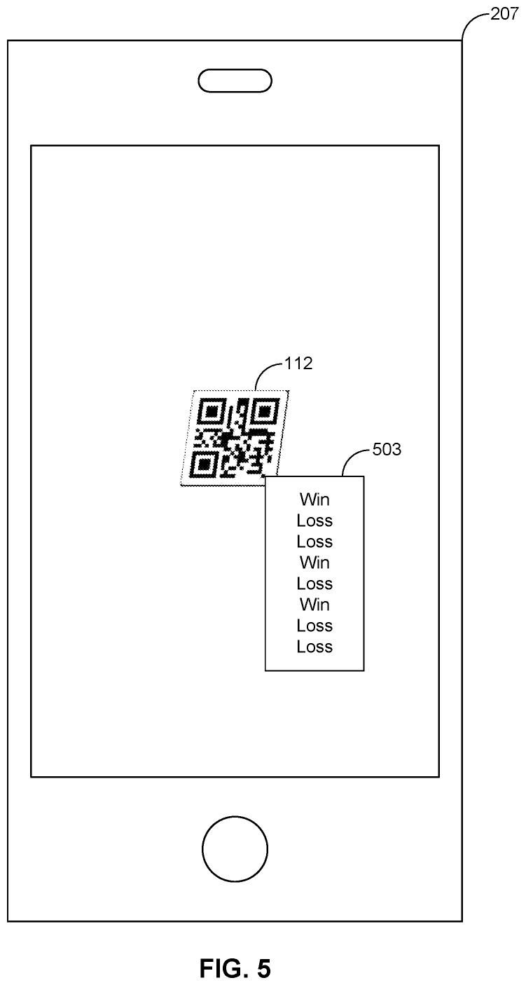

With reference to FIG. 5, shown is a mobile device 207 rendering a user interface according to various embodiments of the present disclosure. The mobile application 242 can identify the scannable code on the ticket 112. The mobile application 242 can render a user interface 503 on the display 245. In some embodiments, the user interface 503 can be rendered in a web browser. In some embodiments, the mobile application 242 can render the user interface 503 overlaid over a camera feed, such as, for example, over an identified scannable code within the camera feed. The mobile application 242 can render the user interface as an augmented reality display on the camera feed. For example, the mobile application 242 can locate the scannable code on the ticket 112 in a three-dimensional space and render the user interface 503 adjacent to the ticket 112. The mobile application 242 can place the user interface 503 as an object next to or on top of the ticket 112. The user interface 503 can include the outcomes of one or more wagering games. For example, the user interface 503 can include 1) whether each outcomes was a win or loss, 2) the time of occurrence for wagering game, 3) the amount won or lost for each outcome, 4) a summary of play information including total amount won or lost, total amount wagered, patron points earned, unlocked benefits, 5) patron information, and other information. In some embodiments, the user interface 503 can include one or more selectable options. For example, the user interface 503 can provide a selectable button to order a drink by touching an input device 248. The selectable buttons can be used to call an attendant, book a reservation at a restaurant, associate the play associated with a scannable code to a patron's account, or some other selectable option.

In some embodiments, the mobile application 242 renders the user interface 503 covered by a graphic covering. The mobile application 242 can simulate a scratch off ticket such that the graphic covering is removed as touch inputs are received via input device 248 across the user interface 503. The mobile application 242 can reveal the results as a patron moves his or her finger across the graphic overlay on the display 245. The mobile application 242 can perform other types of reveals. For example, the mobile application 242 can render a pull tab lottery ticket that when the tab is pulled, the outcomes are revealed. The mobile application 242 can render a set of reels that show one or more reel combinations corresponding to one or more of the outcomes.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include non-transitory computer-readable media for carrying or having computer-executable instructions or data structures stored thereon. Such computer-readable media can be any available media which can be accessed by a computer, or downloadable through communication networks. By way of example, and not limitation, such computer-readable media can include various forms of data storage devices or media such as RAM, ROM, flash memory, EEPROM, CD-ROM, DVD, or other optical disk storage, magnetic disk storage, solid state drives (SSDs) or other data storage devices, any type of removable nonvolatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device 207, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions include, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The processing unit can include one or more hardware processors. The computer will typically include one or more data storage devices for reading data from and writing data to. The data storage devices provide nonvolatile storage of computer-executable instructions, data structures, program modules, and other data for the computer.

Computer program code that implements the functionality described herein typically includes one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In some embodiments, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein. While thresholds are discussed herein as being met when the threshold is exceeded, the system may determine a threshold is met when a value meets or exceeds the threshold.
Clause 1. A system, comprising: a display; a memory device; and at least one computing device communicatively coupled to the memory device and the display, the at least one computing device being configured to: generate a plurality of outcomes for a wagering game; store a record comprising the plurality of outcomes in a data store; rendering a respective celebration on the display for winning ones of the plurality of outcomes; determine a delivery option based on the record; and provide a ticket based on the delivery option, wherein the ticket is configured to display the record in response to an action and hide the record in absence of the action.
Clause 2. The system of clause 1 or any other clause herein, wherein the at least one computing device is further configured to generate a scannable code configured to cause the record to be displayed.
Clause 3. The system of clause 2 or any other clause herein, wherein the scannable code is configured, when scanned, to associate credits from the wagering game to a patron account.
Clause 4. The system of clause 2 or any other clause herein, wherein the scannable code is configured, when scanned, to enable a game feature for the patron account.
Clause 5. The system of clause 1 or any other clause herein, wherein the at least one computing device is further configured to receive a request to cash out the wagering game, wherein the ticket is provided in response to receiving the request.
Clause 6. The system of clause 1 or any other clause herein, wherein the at least one computing device is further configured to provide the ticket in response to generating at least one outcome for the wagering game.
Clause 7. A method, comprising: generating, via one of one or more computing devices, at least one outcome for a wagering game; generating, via one of the one or more computing devices, a record comprising the at least one outcome; determining, via one of the one or more computing devices, a delivery option based on the record; and providing, via one of the one or more computing devices, a ticket based on the delivery option.
8. The method of clause 7 or any other clause herein, further comprising: receiving, via one of the one or more computing devices, credentials for a patron account; authenticating, via one of the one or more computing devices, the credentials for the patron account; and associating, via one of the one or more computing devices, the record with the patron account.
Clause 9. The method of clause 8 or any other clause herein, wherein the ticket comprises instructions for accessing the record via the patron account.
Clause 10. The method of clause 7 or any other clause herein, wherein providing the ticket comprises printing, via a printer, the ticket.
Clause 11. The method of clause 7 or any other clause herein, wherein the record comprises one or more meters associated with the wagering game.
Clause 12. The method of clause 7 or any other clause herein, further comprising presenting, via a display, the record.
Clause 13. The method of clause 7 or any other clause herein, wherein the ticket is configured to display the record in response to an action and hide the record in absence of the action.
Clause 14. The method of clause 7 or any other clause herein, further comprising: generating, via one of the one or more computing devices, a custom URL for accessing the record; and printing, via the printer, the custom URL on the ticket.
Clause 15. A non-transitory computer-readable medium embodying a program that, when executed by at least one computing device, cause the at least one computing device to: generate at least one outcome for a wagering game; generate a record comprising the at least one outcome; determine a delivery option based on the record; and provide a ticket based on the delivery option.
Clause 16. The non-transitory computer-readable medium of clause 15 or any other clause herein, wherein the program further causes the at least one computing device to: request at least one of: a phone number or email address for a current patron account; and transmit the record to the phone number or the email address.
Clause 17. The non-transitory computer-readable medium of clause 16 or any other clause herein, wherein the ticket comprises at least one of: the phone number or the email address.
Clause 18. The non-transitory computer-readable medium of clause 15 or any other clause herein, wherein the program further causes the at least one computing device to: in response to generating the at least one outcome for the wagering game, increment a game counter; determine that the game counter exceeds a predetermined game threshold; and provide the ticket in response to determining that the game counter exceeds the predetermined game threshold.
Clause 19. The non-transitory computer-readable medium of clause 15 or any other clause herein, wherein the program further causes the at least one computing device to: initiate a timer for the wagering game; determine that the timer exceeds a predetermined time threshold; and provide the ticket in response to determining that the timer exceeds the predetermined time threshold.
Clause 20. The non-transitory computer-readable medium of clause 15 or any other clause herein, wherein the program further causes the at least one computing device to transmit the record to a gaming system.

These and other aspects, features, clauses, and benefits of the claims will become apparent from the detailed written description of the aforementioned aspects taken in conjunction with the accompanying drawings, although variations and modifications thereto may be effected without departing from the spirit and scope of the novel concepts of the disclosure.

What is claimed is:

1. A system, comprising:
a display;
a memory device; and
at least one computing device communicatively coupled to the memory device and the display, the at least one computing device being configured to:
generate a plurality of outcomes for a wagering game;
store a record comprising the plurality of outcomes in a data store;
rendering a respective celebration on the display for winning ones of the plurality of outcomes;
determine a delivery option based on the record; and
provide a ticket based on the delivery option, wherein the ticket is configured to display the record in response to an action and hide the record in absence of the action.

2. The system of claim 1, wherein the at least one computing device is further configured to generate a scannable code configured to cause the record to be displayed.

3. The system of claim 2, wherein the scannable code is configured, when scanned, to associate credits from the wagering game to a patron account.

4. The system of claim 2, wherein the scannable code is configured, when scanned, to enable a game feature for the patron account.

5. The system of claim 1, wherein the at least one computing device is further configured to receive a request to cash out the wagering game, wherein the ticket is provided in response to receiving the request.

6. The system of claim 1, wherein the at least one computing device is further configured to provide the ticket in response to generating at least one outcome for the wagering game.

7. A method, comprising:
generating, via one of one or more computing devices, at least one outcome for a wagering game;
generating, via one of the one or more computing devices, a record comprising the at least one outcome;
determining, via one of the one or more computing devices, a delivery option based on the record; and
providing, via one of the one or more computing devices, a ticket based on the delivery option.

8. The method of claim 7, further comprising:
receiving, via one of the one or more computing devices, credentials for a patron account;
authenticating, via one of the one or more computing devices, the credentials for the patron account; and
associating, via one of the one or more computing devices, the record with the patron account.

9. The method of claim 8, wherein the ticket comprises instructions for accessing the record via the patron account.

10. The method of claim 7, wherein providing the ticket comprises printing, via a printer, the ticket.

11. The method of claim 7, wherein the record comprises one or more meters associated with the wagering game.

12. The method of claim 7, further comprising presenting, via a display, the record.

13. The method of claim 7, wherein the ticket is configured to display the record in response to an action and hide the record in absence of the action.

14. The method of claim 7, further comprising:
generating, via one of the one or more computing devices, a custom URL for accessing the record; and
printing, via the printer, the custom URL on the ticket.

15. A non-transitory computer-readable medium embodying a program that, when executed by at least one computing device, cause the at least one computing device to:
generate at least one outcome for a wagering game;
generate a record comprising the at least one outcome;
determine a delivery option based on the record; and
provide a ticket based on the delivery option.

16. The non-transitory computer-readable medium of claim 15, wherein the program further causes the at least one computing device to:
request at least one of: a phone number or email address for a current patron account; and
transmit the record to the phone number or the email address.

17. The non-transitory computer-readable medium of claim 16, wherein the ticket comprises at least one of: the phone number or the email address.

18. The non-transitory computer-readable medium of claim 15, wherein the program further causes the at least one computing device to:
in response to generating the at least one outcome for the wagering game, increment a game counter;
determine that the game counter exceeds a predetermined game threshold; and
provide the ticket in response to determining that the game counter exceeds the predetermined game threshold.

19. The non-transitory computer-readable medium of claim 15, wherein the program further causes the at least one computing device to:
initiate a timer for the wagering game;
determine that the timer exceeds a predetermined time threshold; and
provide the ticket in response to determining that the timer exceeds the predetermined time threshold.

20. The non-transitory computer-readable medium of claim 15, wherein the program further causes the at least one computing device to transmit the record to a gaming system.
